(19) United States
(12) Patent Application Publication
(10) Pub. No.: US 2025/0317870 A1
(43) Pub. Date: Oct. 9, 2025

(54) SYSTEM AND METHOD FOR MULTIPLE ACCESS BASED ON POWER PROFILES

(71) Applicant: Huawei Technologies Co., Ltd., Shenzhen (CN)

(72) Inventors: Sanjeewa Herath, Ottawa (CA); Lei Wang, Shanghai (CN); Jianglei Ma, Ottawa (CA)

(21) Appl. No.: 19/187,548

(22) Filed: Apr. 23, 2025

Related U.S. Application Data
(63) Continuation of application No. PCT/CN2022/129981, filed on Nov. 4, 2022.

(51) Int. Cl. H04W 52/32; H04L 5/00

(52) U.S. Cl. CPC H04W 52/325; H04L 5/0053

(57) ABSTRACT

A method of transmission and reception is provided in which the power of each modulated constellation symbol of a sequence of modulated symbols to be transmitted is set according to a respective amplitude scaling factor of a known power profile. The power profile is known in the sense that the entire set of amplitude scaling factors of the power profile is known to both transmitter and receiver before it is applied. Examples of such a power profile include a power control pattern or a power allocation pattern.

### CROSS-REFERENCE TO RELATED APPLICATION

This application is a continuation of International Application No. PCT/CN2022/129981, filed on Nov. 4, 2022, titled “SYSTEM AND METHOD FOR MULTIPLE ACCESS BASED ON POWER PROFILES,” which is hereby incorporated by reference in its entirety.

### TECHNICAL FIELD

The application relates to wireless communications generally, and more specifically to systems and methods of multiple access in wireless communications systems.

### BACKGROUND

In machine type communication (MTC), it is very common that a cluster or a group of user equipment (UE) to communicate with the one or more base station(s) (BSs) on the network side. The UE can be a sensor, machine type device, internet of things (IoT) device or other. Such a scenario may be very common in a factory industrial environment such as an assembly line. The link from the UE side to network/BS(s) is commonly referred to as the uplink, and the link from the BS/network to the UE side is commonly referred to as the downlink; a link between one UE and another UE is commonly referred to as the sidelink. The signal from a transmitter to a receiver is propagated over a propagation channel, commonly known as channel. The channel can be characterized by its statistical nature or random variable(s). For example, a channel from a transmitter to a receiver can be characterized by many random parameters such as amplitude, phase, angle of arrival (AoA), angle of departure (AoD), path loss, spatial parameters such as AoA, dominant AoA, average AoA, power angular spectrum (PAS) of AoA, average AoD, PAS of AoD), Doppler spread/shift, delay, delay spread. In some scenarios, one or more of channels or channel parameters can be correlated with another channel or channel parameters. Such channels can be uplink or downlink or sidelink channels. The channel correlation means that one or several parameters of the propagation channels are correlated or interdependent. Such parameters show a statistical relationship between them or some other form of associations. Correlation normally can refer to the degree to which one parameter provides statistical information about the other. In a specific example, an uplink channel from a first UE to a BS can be correlated with another uplink channel from a second UE to the BS. In another specific example, an uplink channel from the first antenna of a first UE to a BS can be correlated to an uplink channel from the second antenna of the first UE to the BS.

The most familiar measure of dependence between two quantities is the Pearson product-moment correlation coefficient (PPMCC), or commonly called “the correlation coefficient.” The correlation coefficient is obtained by taking the ratio of the covariance of the two quantities, normalized to the square root of their variances. If the variables are independent, the correlation coefficient is 0. A non-zero correlation coefficient indicates a form of dependence between the quantities. In a specific scenario, full correlation means the absolute value of the correlation coefficient is 1, i.e., one quantity fully characterizes the other such that there is full dependence.

Correlation in physical channels can occur due to various reasons. For example, when two antennas are closely placed in an antenna array, their channels can be correlated. When a cluster/group of UEs are geographically close to one another, their propagation channels can be highly correlated or their path loss/propagation loss can be very similar. When channels are highly correlated, it means their propagation characteristics are very similar as well.

When two transmissions are propagated to a receiver over dissimilar channels (e.g. independent channels), although they interfere to one another, these transmissions can be separated at the receiver using the dissimilar channels. When channels are highly correlated, the channels are similar and therefore, it is difficult for the receiver to separate those signals.

### SUMMARY

In accordance with an embodiment of the disclosure, the power of each modulated constellation symbol of a sequence of modulated symbols to be transmitted is set according to a respective amplitude scaling factor of a known power profile. The power profile is known in the sense that the entire set of amplitude scaling factors of the power profile is known to both transmitter and receiver before it is applied. The set of amplitude scaling factors applied to the sequence of modulated symbols of a given transmission is collectively referred to herein as the power profile. More generally, each of a plurality of parts of a signal has a respective amplitude scaling factor from the known power profile applied. Examples of such a power profile include a power control pattern or a power allocation pattern, both described in detail below. In this embodiment, the power profile is also referred to herein as an intra-slot power profile. The power profile may be provided to the transmitter side through signaling such as radio resource control (RRC), medium access control-control entity (MAC-CE), downlink control information (DCI) signaling or a combination thereof. In some scenarios such as a grant-based or scheduled transmission scenario, the power profile is assigned/configured to the transmitter from the network side while in some other scenarios such as grant-free or configured-grant transmission scenario, the transmitter may select/choose/determine one power profile out of a table or pool of power profiles. Configurations such as time granularity, frequency granularity, amplitude scaling factors and other transmission parameters and configurations are signaled from the network side in advance through signaling such as RRC, MAC-CE, DCI signaling or a combination thereof. After applying the power profile to the sequence of modulated symbols, a waveform operation such as DFT spreading (for DFT spread OFDM) may be performed. In some other embodiments, DFT spreading may be performed before applying the power profile/amplitude scaling factors.

According to one aspect of the present disclosure, there is provided a method comprising: communicating a signal over a wireless communications channel, the signal being based on a plurality of parts to each of which a respective one of a plurality of amplitude scaling factors has been applied, the plurality of amplitude scaling factors collectively forming a known power control pattern or a known power allocation pattern.

In some embodiments, the amplitude scaling factors do not depend on data carried by the signal.

In some embodiments, communicating a signal comprises transmitting the signal.

In some embodiments, communicating a signal comprises receiving the signal.

In some embodiments, the plurality of parts comprise: a plurality of modulated symbols; or a plurality of groups of resource elements; or a plurality of groups of modulated symbols; or a plurality of groups of subcarriers; or a plurality of resource blocks; or a plurality of modulated symbols for transmitting a forward error correction (FEC) codeword; or a plurality of OFDM symbols; or a plurality of slots in the time domain; a plurality of retransmissions; or a plurality of repetitions.

In some embodiments, the method further comprises performing power control pattern or power allocation pattern hopping in time or in frequency or in time and frequency.

In some embodiments, the method further comprises obtaining the power control pattern or power allocation pattern from a pool of power control patterns or power allocation patterns.

In some embodiments, obtaining the power control pattern or power allocation pattern from a pool of power control patterns or power allocation patterns comprises: choosing the power control pattern or power allocation pattern or an index of the power control pattern or power allocation pattern at random; obtaining an index of the power control pattern or power allocation pattern using a formula; choosing the power control pattern or power allocation pattern to achieve an acceptable PAPR; measuring a channel to obtain channel measurements and choosing the power control pattern or power allocation pattern based on channel measurements; receiving feedback reflecting channel measurements and choosing the power control pattern or power allocation pattern based on the feedback.

In some embodiments, the method further comprises communicating signaling defining one or more of: the power control pattern or power allocation pattern; or an index of the power control pattern or power allocation pattern within a pool of power control patterns or power allocation patterns; or configuration of bit-level processing to be performed as part of generating the signal; or configuration of symbol-level processing to be performed as part of generating the signal; or configuration of bits-to-symbol mapping to be performed as part of generating the signal.

In some embodiments, the signal is a non-orthogonal multiple access (NoMA) signal, and wherein the signal has a multiple access (MA) signature based at least in part on the power control pattern or power allocation pattern.

In some embodiments, the method further comprises obtaining channel measurements and transmitting information concerning the channel measurements to a transmitter for use in determining the power control pattern or power allocation pattern.

In some embodiments, the method further comprises receiving one or more power control commands that cause the signal to be transmitted with the power control pattern or power allocation pattern.

In some embodiments, the method further comprises transmitting one or more power control commands that cause the signal to be transmitted with the power control pattern or power allocation pattern.

In some embodiments, the method further comprises communicating signaling enabling or disabling the application of the plurality of amplitude scaling factors.

According to another aspect of the present disclosure, there is provided a network device comprising: a processor and a memory, the network device configured to perform a method for receiving downlink control information (DCI), the method comprising: communicating a signal over a wireless communications channel, the signal being based on a plurality of parts to each of which a respective one of a plurality of amplitude scaling factors has been applied, the plurality of amplitude scaling factors collectively forming a known power control pattern or a known power allocation pattern.

In some embodiments, the amplitude scaling factors do not depend on data carried by the signal.

In some embodiments, wherein communicating a signal comprises transmitting the signal.

In some embodiments, communicating a signal comprises receiving the signal.

In some embodiments, the plurality of parts comprises: a plurality of modulated symbols; or a plurality of groups of resource elements; or a plurality of groups of modulated symbols; or a plurality of groups of subcarriers; or a plurality of resource blocks; or a plurality of modulated symbols for transmitting a forward error correction (FEC) codeword; or a plurality of OFDM symbols; or a plurality of slots in the time domain; or a plurality of retransmissions; or a plurality of repetitions.

In some embodiments, the method the network device is configured to perform further comprises performing power control pattern or power allocation pattern hopping in time or in frequency or in time and frequency.

In some embodiments, the method the network device is configured to perform further comprises: obtaining the power control pattern or power allocation pattern from a pool of power control patterns or power allocation patterns.

In some embodiments, obtaining the power control pattern or power allocation pattern from a pool of power control patterns or power allocation patterns comprises: choosing the power control pattern or power allocation pattern or an index of the power control pattern or power allocation pattern at random; obtaining an index of the power control pattern or power allocation pattern using a formula; choosing the power control pattern or power allocation pattern to achieve an acceptable PAPR; measuring a channel to obtain channel measurements and choosing the power control pattern or power allocation pattern based on channel measurements; receiving feedback reflecting channel measurements and choosing the power control pattern or power allocation pattern based on the feedback.

In some embodiments, the method the network device is configured to perform comprises communicating signaling defining one or more of: the power control pattern or power allocation pattern; or an index of the power control pattern or power allocation pattern within a pool of power control patterns or power allocation patterns; or configuration of bit-level processing to be performed as part of generating the signal; or configuration of symbol-level processing to be performed as part of generating the signal; or configuration of bits-to-symbol mapping to be performed as part of generating the signal.

In some embodiments, the signal is a non-orthogonal multiple access (NoMA) signal, and wherein the signal has a multiple access (MA) signature based at least in part on the power control pattern or power allocation pattern.

In some embodiments, the method the network device is configured to perform further comprises: obtaining channel measurements and transmitting information concerning the channel measurements to a transmitter for use in determining the power control pattern or power allocation pattern.

In some embodiments, the method the network device is configured to perform further comprises: receiving one or more power control commands that cause the signal to be transmitted with the power control pattern or power allocation pattern.

In some embodiments, the method the network device is configured to perform further comprises: transmitting one or more power control commands that cause the signal to be transmitted with the power control pattern or power allocation pattern.

In some embodiments, the method the network device is configured to perform further comprises: communicating signaling enabling or disabling the application of the plurality of amplitude scaling factors.

According to another aspect of the present disclosure, there is provided an apparatus comprising a processor and a memory, the apparatus configured to perform a method for receiving downlink control information (DCI), the method comprising: communicating a signal over a wireless communications channel, the signal being based on a plurality of parts to each of which a respective one of a plurality of amplitude scaling factors has been applied, the plurality of amplitude scaling factors collectively forming a known power control pattern or a known power allocation pattern.

In some embodiments, the amplitude scaling factors do not depend on data carried by the signal.

In some embodiments, communicating a signal comprises transmitting the signal.

In some embodiments, communicating a signal comprises receiving the signal.

In some embodiments, the plurality of parts comprises: a plurality of modulated symbols; or a plurality of groups of resource elements; or a plurality of groups of modulated symbols; or a plurality of groups of subcarriers; or a plurality of resource blocks; or a plurality of modulated symbols for transmitting a forward error correction (FEC) codeword; or a plurality of OFDM symbols; or a plurality of slots in the time domain; or a plurality of retransmissions; or a plurality of repetitions.

In some embodiments, the method the apparatus is configured to perform further comprises performing power control pattern or power allocation pattern hopping in time or in frequency or in time and frequency.

In some embodiments, the method the apparatus is configured to perform further comprises: obtaining the power control pattern or power allocation pattern from a pool of power control patterns or power allocation patterns.

In some embodiments, obtaining the power control pattern or power allocation pattern from a pool of power control patterns or power allocation patterns comprises: choosing the power control pattern or power allocation pattern or an index of the power control pattern or power allocation pattern at random; obtaining an index of the power control pattern or power allocation pattern using a formula; choosing the power control pattern or power allocation pattern to achieve an acceptable PAPR; measuring a channel to obtain channel measurements and choosing the power control pattern or power allocation pattern based on channel measurements; receiving feedback reflecting channel measurements and choosing the power control pattern or power allocation pattern based on the feedback.

In some embodiments, the method the apparatus is configured to perform comprises communicating signaling defining one or more of: the power control pattern or power allocation pattern; or an index of the power control pattern or power allocation pattern within a pool of power control patterns or power allocation patterns; or configuration of bit-level processing to be performed as part of generating the signal; or configuration of symbol-level processing to be performed as part of generating the signal; or configuration of bits-to-symbol mapping to be performed as part of generating the signal.

In some embodiments, the signal is a non-orthogonal multiple access (NoMA) signal, and wherein the signal has a multiple access (MA) signature based at least in part on the power control pattern or power allocation pattern.

In some embodiments, the method the apparatus is configured to perform further comprises: obtaining channel measurements and transmitting information concerning the channel measurements to a transmitter for use in determining the power control pattern or power allocation pattern.

In some embodiments, the method the apparatus is configured to perform further comprises: receiving one or more power control commands that cause the signal to be transmitted with the power control pattern or power allocation pattern.

In some embodiments, the method the apparatus is configured to perform further comprises: transmitting one or more power control commands that cause the signal to be transmitted with the power control pattern or power allocation pattern.

In some embodiments, the method the apparatus is configured to perform further comprises: communicating signaling enabling or disabling the application of the plurality of amplitude scaling factors.

### BRIEF DESCRIPTION OF THE DRAWINGS

Embodiments of the disclosure will now be described with reference to the attached drawings.

FIG. 1 is a block diagram of a communication system.

FIG. 2 is a block diagram of a communication system.

FIG. 3 is a block diagram of a communication system showing a basic component structure of an electronic device (ED) and a base station.

FIG. 4 is a block diagram of modules that may be used to implement or perform one or more of the steps of embodiments of the application.

FIG. 5 is a block diagram of a transmitter that applies a power profile, provided by an embodiment of the application.

FIG. 6 is a block diagram of a multi-user receiver.

FIG. 7 contains examples of profile hopping in time, frequency or both.

FIG. 8 contains a further set of examples of profile hopping in time, frequency or both.

FIGS. 9 and 10 are flowcharts showing the exchange of signaling information.

FIG. 11 depicts an example of applying the provided power profile/profile for multiple slot transmission.

### DETAILED DESCRIPTION

Different techniques may be used to separate the transmissions that are sent over correlated channels. One such method is to use orthogonal resources for each transmission. When two transmissions use orthogonal physical resources, commonly known as orthogonal multiple access (OMA), every transmission requires distinct physical resources which leads to poor physical resource usage and hence less throughput in the system. In another approach, non-orthogonal multiple access (NoMA) can be used, where signatures that are orthogonal (orthogonal signatures have zero correlation between signatures) or near orthogonal (near orthogonal means that the correlation between the signatures is low) can be used to separate the transmissions. However, only a certain number of near-orthogonal or orthogonal signatures can be defined for a given physical resource with a given level of signature correlation. As a result, OMA or orthogonal/near-orthogonal signature based approaches can lead to poor system efficiency as well.

In another approach, power domain NoMA can be used. In power domain NoMA, transmissions with dissimilar receive power levels are transmitted/scheduled in the same physical resource and using the difference in receive power levels, a receiver discriminates multiple transmissions. However, in a correlated channel scenario where multiple transmissions are highly correlated and the receive signals tend to have similar power levels, it is difficult to use the power domain NoMA technique to separate individual signals at the receiver side. This is because, if one transmission power is lowered compared to another (using a power gain or power scaling factor) in order to create dissimilar power levels at the receiver, for sufficient separation and detection, one transmission power should be lowered significantly compared to the other transmission. The lower power transmission may need to use a lower modulation and coding scheme (MCS) and consequently, risks rate loss and/or outage (i.e., decoding errors due to lower received power). Furthermore, to implement a system that involves dynamically adjusting the power levels through a power control mechanism (open loop power control or closed loop power control) in order to create sufficient power level difference with good detection performance may require a sophisticated power control mechanism and may increase the signaling overhead. Such issues exist in both grant-free and grant-based transmissions. Note that in such a power control mechanism, the transmit signal power is adjusted for the entire transmission/packet and therefore, the power adjustment is done for entire signal/sequence of symbols. The power domain NoMA scheme may work well when the channels are not very correlated but may fail in the correlated channel scenario.

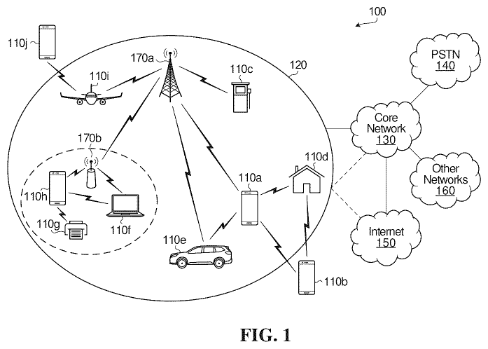

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

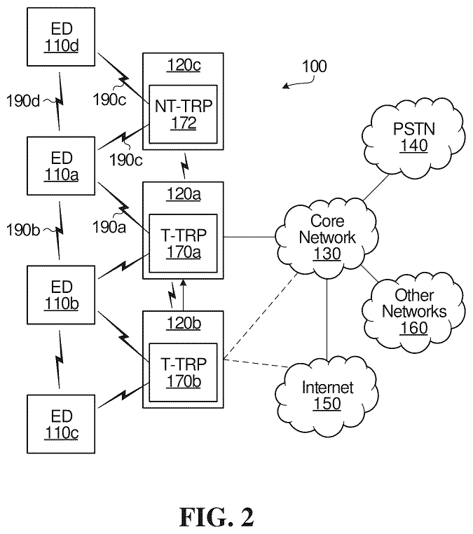

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

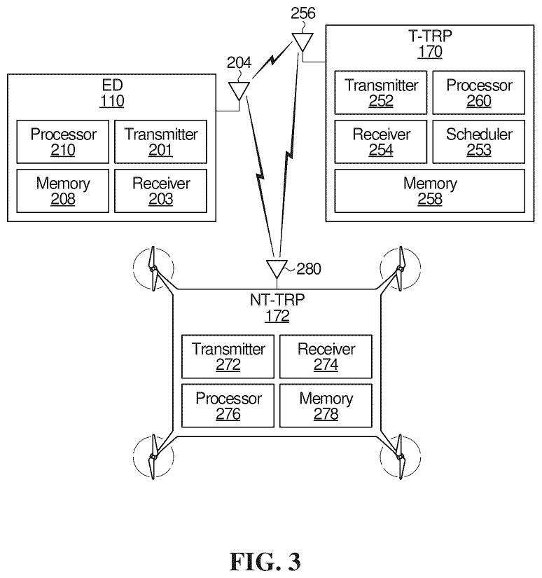

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

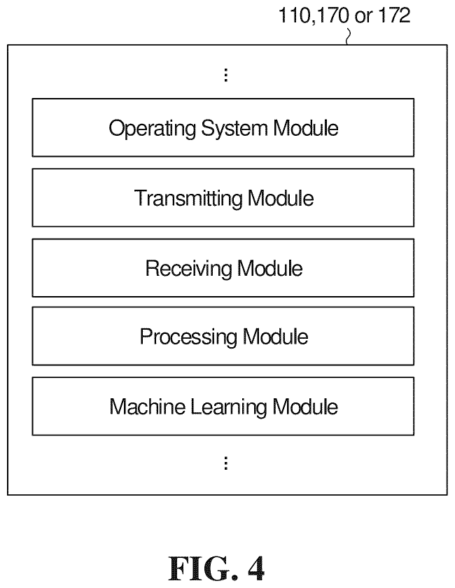

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

In accordance with an embodiment of the disclosure, the power of each modulated constellation symbol of a sequence of modulated symbols to be transmitted is set according to a respective amplitude scaling factor of a known power profile. The power profile is known in the sense that the entire set of amplitude scaling factors of the power profile is known to both transmitter and receiver before it is applied. The set of amplitude scaling factors applied to the sequence of modulated symbols of a given transmission is collectively referred to herein as the power profile. More generally, each of a plurality of parts of a signal has a respective amplitude scaling factor from the known power profile applied. Examples of such a power profile include a power control pattern or a power allocation pattern, both described in detail below. In this embodiment, the power profile is also referred to herein as an intra-slot power profile. The power profile may be provided to the transmitter side through signaling such as radio resource control (RRC), medium access control-control entity (MAC-CE), downlink control information (DCI) signaling or a combination thereof. In some scenarios such as a grant-based or scheduled transmission scenario, the power profile is assigned to the transmitter from the network side while in some other scenarios such as grant-free or configured-grant transmission scenario, the transmitter may select/choose/determine one power profile out of a table or pool of power profiles. Configurations such as time granularity, frequency granularity, amplitude scaling factors and other transmission parameters and configurations are signaled from the network side in advance through signaling such as RRC, MAC-CE, DCI signaling or a combination thereof. After applying the power profile to the sequence of modulated symbols, a waveform operation such as DFT spreading (for DFT spread OFDM) may be performed. In some other embodiments, DFT spreading may be performed before applying the power profile/amplitude scaling factors.

In another embodiment, an initial transmission of a sequence of modulated symbols takes place in one slot, and two or more repetitions or retransmissions with a configured-grant periodicity take place in respective further slots, and a known power profile is applied across the two or more repetitions or retransmissions. The power of each retransmission is set according to a respective amplitude scaling factor of a known power profile. The power profile for such a case is also referred to herein as an inter-slot power profile.

In the above example of intra-slot power profile, a respective amplitude scaling factor is applied to each modulated symbol. In applications where the power adjusted symbols are input to an IFFT, each subcarrier has its own amplitude scaling factor. In some embodiments, the prior known power profile includes amplitude scaling factors specified per group of subcarriers or per RB(s) in frequency domain. In some other embodiments, the prior known power profile includes amplitude scaling factors specified per OFDM symbol or per slot in the time domain. In some other embodiments, the prior known power profile includes amplitude scaling factors specified to some granularity. A specific non-limiting set of examples includes amplified scaling factors specified for one of:
per group of modulated symbols;
per group of resource elements (REs);
per resource element group (REG);
per resource block group (RBG); or
per sub-band.

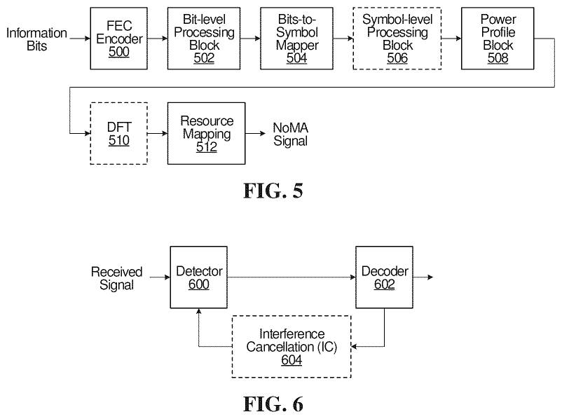

An example transmitter block diagram is shown in FIG. 5. An information bit sequence is first encoded by the forward error correction (FEC) encoder 500 to produce a sequence of encoded bits. The encoded bits may be further processed in a bit-level processing block 502 which may perform one or more bit-level operations. In general, the bit-level processing block 502 performs one or more bit-level or bit-domain operations such as bit interleaving, bit repetition, bit permutation, bit scrambling, bit puncturing or bit pruning. Bit interleaving may refer to a change of bit location. Bit scrambling may refer to exclusive-OR (XOR) with a known/given another bit sequence (for example, XOR the encoded information bit sequence with a known bit sequence such as the identifier (ID) of the UE (UE_ID) where UE_ID is a Radio Network Temporary Identifier (RNTI)). Bit permutation may mean permuting the bit location. Bit puncturing or pruning may mean removing certain bits. The bit-level operations may be controlled or configured by an input control signaling i₁. For example, one value of i₁ indicates that bits-level processing block performs bit scrambling, another value of i₁ indicates that bits-level processing block performs bit interleaving and yet another value of i₁ indicates that bits-level processing block performs both bit scrambling and bit interleaving etc.

The output bit stream is mapped to symbols with bits-to-symbol mapper 504 to produce a sequence of modulated symbols. The bits-to-symbol mapper 504 may be a standard modulator such as

$$BPSK , \frac{π}{2} - BPSK , QPSK , 16 \text{-} QAM , 256 \text{-} QAM , 1024 \text{-} QAM ( m \text{-} QAM ) .$$

The standard modulator is a modulation mapper that takes binary digits, 0 or 1, as input and produces complex-valued modulation symbols as output. The bits-to-symbol mapper 504 may implement a multi-dimensional modulation such as 8-point, 16-point, 64-point SCMA modulation. In general, the bits-to-symbol mapper 504 maps the input bits to symbols. The bits-to-symbol mapper 504 may use a bits-to-symbol mapping to map the bit sequence to a sequence of symbols. Bits-to-symbol mapping 504 may, for example, use the bits-to-symbol mapping method defined in the modulation mapper in 3GPP TS 38.211 V17.2.0 (2022-06) (legacy NR modulation). In another example, the bits-to-symbol mapping implements an m₁-bit to n₁-symbol mapping that may be represented by a table in which each column represents the symbol sequence in terms of an index of the input bit stream. In some embodiments, the mapping may incorporate linear or non-linear spreading.

The functionality of the bits-to-symbol mapper 504 may alternatively be presented by a formula expressing the relation between the input bit stream b and the output symbol sequence x. For example, the formula of an 8-point modulated symbol sequence of length-two may be given as:

$$x = \sqrt{\frac{2}{3}} [ \begin{matrix}- \frac{1}{\sqrt{2}} & j & 0 \\ - \frac{1}{\sqrt{2}} & 0 & j\end{matrix} ] ( 1 - 2 b ) \qquad ( 1 )$$

where b is the information bit sequence of length-three and x is the output two symbols. The two symbols in x have a relationship defined by the input bits. This is known as non-linear spreading. Moreover, a block of bits (3 bits in this example) produces two symbols in one step, this process may also be referred as multi-dimensional modulation. The bits-to-symbol mapper 504 may embed a device-based signature (fully or partially) to the output sequence of symbols. The operations may be controlled or configured, for example, by an input control signaling i₂. For example, one value of i₂ indicates that bits-to-symbol mapping block performs legacy modulation, another value of i₂ indicates that bits-to-symbol mapping block performs multi-dimensional modulation or non-linear spreading, yet another value of i₂ indicates that bits-to-symbol mapping block performs linear spreading etc.

The modulated symbol sequence produced at the output of the bits-to-symbol mapper 504 may be further processed at a symbol-level processing block 506 which may perform one or more of symbol-level processing operations such as sparse or non-sparse spreading, sparse or non-sparse mapping, symbol scrambling.

For example, symbol-level processing block 506 may be spread symbols and this operation may be referred as spreading. Spread symbols may be symbol spread with linear spreading or non-linear spreading. In linear spreading, spread symbols have a linear relationship among them. For example, a symbol s₁ spread with spreading sequence [1, −1] produces a symbol sequence [s₁, −s₁] and s₁ spread with spreading sequence [1, 1] produces a symbol sequence [s₁, s₁].

On the other hand, in non-linear spreading, the relationship between the spread symbols is associated with the mapping bits. For example, bits 00, 01, 10 may map to symbols s₁, s₂, s₃, and then bit sequence 010 may be spread to 0110 (by duplicating the middle bit) and map to symbol sequence [s₂, s₃] and bit sequence 101 may be spread to 1001 and map to symbol sequence [s₃, s₂]. As such the relationship of the symbols is defined in the bit domain. Non-linear spreading may be referred to as multidimensional modulation as well. As such by suitably defining a bits-to-symbol mapping, non-linear spreading may be achieved.

The spreading may be sparse spreading or non-sparse spreading. In sparse spreading, spreading involves use of the zero symbol (a symbol “0” with zero power). For example, symbol s₁ sparse-spread by sparse sequence [1, 0] produces symbol sequence [s₁, 0]. Sparse spreading may also refer to as sparse mapping. The symbols may be scrambled symbols. For example, symbol sequence [s₁, s₂] scrambled by scrambling sequence [1, −1] produces the symbol sequence [s₁, −s₂]. Symbols may be multiplied by a cover code, that is, symbol sequence [s₁, s₂] scrambled by scrambling sequence [1, −1] produces the symbol sequence [s₁, −s₂]. Other symbol domain operations such as symbol interleaving may be performed (changing the location of the symbols, symbol permutation).

A group of N symbols (modulated symbols or output of the symbol-level processing block 506) output by the bits-to-symbol mapper 504 (or symbol-level processing block 506 if present) are processed by power profile block 508 according to a power profile, such as a power control pattern or a power allocation pattern. The power profile block applies a respective one of a plurality of amplitude scaling factors to each modulated symbol (more generally to each of a plurality of parts of the signal). In some embodiments, the amplitude scaling factors do not depend on the data/information bits carried by the signal. In some embodiments, further symbol processing (not shown) is applied to the output of the power profile block. In yet another alternative implementation, the functionality of the power profile block 508 is implemented within the symbol-level processing block 506, and a power profile is applied for a specific control input of the symbol-level processing block 506. The operations of such a symbol-level processing block may be controlled or configured by an input control signaling i₃. For example, one value of i₃ indicates that the symbol-level processing block performs linear spreading, another value of i₃ indicates that the symbol-level processing block performs non-linear spreading, yet another value of i₃ indicates that the symbol-level processing block performs sparse spreading or sparse mapping, yet another value of i₃ indicates that the symbol-level processing block performs the application of a power profile to the input symbols, yet another value of i₃ indicates that the symbol-level processing block applies spreading and power profiling, yet another value of i₃ indicates that the symbol-level processing block applies non-linear spreading and power profiling etc.

Specific examples of power profiles are shown in Table 1. The power profile for a block of symbols of size N is shown in Table 1 where the second column shows power profiles for N=6 and the third column shows power profiles for N=18. There are m=20 profiles indexed from 0, . . . , 19 for N=6 and there are m=18 profiles indexed from 0, . . . , 17 for N=18. N=6 and N=18 are only specific examples and various lengths power profiles can be defined. All m profiles specified in a table or formula or other ways are indexed from 0, . . . , m−1 and can form a pool of power profiles. A subset of profiles from a pool can be another pool. For example, profiles with indices 0 and 1 for either N=6 or N=18 can be another pool. Such a subset pool may be of particular interest in some scenarios where such power profiles may have low-PAPR compared other profiles in the pools. As such, based on the PAPR levels or other methods, multiple sub-pools or sub-groups of profiles can be defined.

TABLE 1
EXAMPLE POWER PROFILE/PROFILE

| | Power profile | Power profile |
|---|---|---|
| Index | (p₁ᵢ, p₂ᵢ, p₃ᵢ, p₄ᵢ, p₅ᵢ, p₆ᵢ)^{T}, | (p₁ᵢ, p₂ᵢ, . . . , p_{Ni})^{T}, |
| (i) | N = 6 | N = 18 |
| 0 | (+x, −x, +x, −x, +x, −x)^{T} | (+x, −x, +x, −x, +x, −x, +x, −x, +x, −x, +x, −x, +x, −x, +x, −x, +x, −x)^{T} |
| 1 | (−x, +x, −x, +x, −x, +x)^{T} | (−x, +x, −x, +x, −x, +x, −x, +x, −x, +x, −x, +x, −x, +x, −x, +x, −x, +x)^{T} |
| 2 | (+x, +x, +x, −x, −x, −x)^{T} | (+x, −x, +x, −x, +x, −x, +x, −x, +x, −x, +x, −x, +x, −x, +x, −x, −x, +x)^{T} |
| 3 | (−x, −x, −x, +x, +x, +x)^{T} | (+x, −x, +x, −x, +x, −x, +x, −x, +x, −x, +x, −x, +x, −x, −x, +x, −x, +x)^{T} |
| 4 | (+x, +x, −x, +x, −x, −x)^{T} | (+x, −x, +x, −x, +x, −x, +x, −x, +x, −x, +x, −x, −x, +x, −x, +x, −x, +x)^{T} |
| 5 | (−x, −x, +x, −x, +x, +x)^{T} | (+x, −x, +x, −x, +x, −x, +x, −x, +x, −x, −x, +x, −x, +x, −x, +x, −x, +x)^{T} |
| 6 | (−x, −x, +x, −x, +x, −x)^{T} | (+x, −x, +x, −x, +x, −x, +x, −x, −x, +x, −x, +x, −x, +x, −x, +x, −x, +x)^{T} |
| 7 | (−x, −x, +x, +x, −x, +x)^{T} | (+x, −x, +x, −x, +x, −x, −x, +x, −x, +x, −x, +x, −x, +x, −x, +x, −x, +x)^{T} |
| 8 | (+x, +x, −x, −x, −x, +x)^{T} | (+x, −x, +x, −x, −x, +x, −x, +x, −x, +x, −x, +x, −x, +x, −x, +x, −x, +x)^{T} |
| 9 | (−x, −x, +x, +x, +x, −x)^{T} | (+x, −x, −x, +x, −x, +x, −x, +x, −x, +x, −x, +x, −x, +x, −x, +x, −x, +x)^{T} |
| 10 | (+x, −x, +x, +x, −x, −x)^{T} | (−x, +x, +x, −x, +x, −x, +x, −x, +x, −x, +x, −x, +x, −x, +x, −x, +x, −x)^{T} |
| 11 | (−x, +x, −x, −x, +x, +x)^{T} | (−x, +x, −x, +x, +x, −x, +x, −x, +x, −x, +x, −x, +x, −x, +x, −x, +x, −x)^{T} |
| 12 | (+x, −x, +x, −x, −x, +x)^{T} | (−x, +x, −x, +x, −x, +x, +x, −x, +x, −x, +x, −x, +x, −x, +x, −x, +x, −x)^{T} |
| 13 | (−x, +x, −x, +x, +x, −x)^{T} | (−x, +x, −x, +x, −x, +x, −x, +x, +x, −x, +x, −x, +x, −x, +x, −x, +x, −x)^{T} |
| 14 | (+x, −x, −x, +x, +x, −x)^{T} | (−x, +x, −x, +x, −x, +x, −x, +x, −x, +x, +x, −x, +x, −x, +x, −x, +x, −x)^{T} |
| 15 | (−x, +x, +x, −x, −x, +x)^{T} | (−x, +x, −x, +x, −x, +x, −x, +x, −x, +x, −x, +x, +x, −x, +x, −x, +x, −x)^{T} |
| 16 | (+x, −x, −x, +x, −x, +x)^{T} | (−x, +x, −x, +x, −x, +x, −x, +x, −x, +x, −x, +x, −x, +x, +x, −x, +x, −x)^{T} |
| 17 | (−x, +x, +x, −x, +x, −x)^{T} | (−x, +x, −x, +x, −x, +x, −x, +x, −x, +x, −x, +x, −x, +x, −x, +x, +x, −x)^{T} |
| 18 | (+x, −x, −x, −x, +x, +x)^{T} | |
| 19 | (−x, +x, +x, +x, −x, −x)^{T} | |

According to the amplitude scaling factors specified in a particular power profile, the symbol power is adjusted. As an example, index 0 of Table 1 for N=6, the power profile is (+x, −x, +x, −x, +x, −x)^{T}. This means that input symbols (e.g. power normalized symbols) will be adjusted to the specified values in (+x, −x, +x, −x, +x, −x)^{T}. For example, the power of a block of power normalized symbols (s₀, s₁, s₂, s₃, s₄, s₅)^{T} will be adjusted according to the (+x, −x, +x, −x, +x, −x)^{T}, i.e., the power of so is adjusted x dB higher power and the power of s₁ is adjusted x dB lower power etc. The value of x may be specified by RRC signaling or other method to the transmitter side. A set of power normalized symbol has average power 1, i.e., [symbol] (sᵢ)=1, i∈{0, . . . , 5}. The power adjustment can be viewed as amplitude adjustment. For example, y=αs₀ where y has x dB higher power than so. For example, with

$$α = \sqrt{1 {0}^{\frac{x}{10}}} ,$$

y has x dB higher power than so. Observe that for the power profiles shown in Table 1, each power profile has an equal number of positive (+) values and negative (−) values which makes the power of the output of the power profile symbols the same as the power of the symbols before applying the power profile. Although the power profiles in Table 5 are defined with only one value x, more generally, power profiles can be defined with more than one value. As an example, (+x₁, −x₁, +x₂, −x₂, +x₁, −x₁)™ can be defined as a power profile with two values x₁, x₂. For implementation purpose or representation purpose, the application of a power profile can be expressed in mathematical notations or symbols. For example, symbol block (s₀, s₁, s₂, s₃, s₄, s₅)^{T} can be multiplied by a diagonal matrix P where P specifies the amplitude scaling factors obtained from a specified power profile.

The index of a specific power profile to use may be assigned to a transmitter by RRC, MAC-CE, DCI, L1/L2 control signaling, as a result of which the power profile becomes known to both the transmitter and the receiver. In some embodiments, this approach is applied in grant-based transmission. Alternatively, the transmitter may choose the power profile index at random. Alternatively, the transmitter may select, choose or determine the power profile index from a formula, for example, mod (ƒ(SEED), POOL_SIZE) where SEED is an input to the function ƒ(⋅). For example, SEED may be a transmitter specific identifier such as a radio network temporary identifier (RNTI) (an example of a UE identifier), or a random number assigned by the network or generated by the device/UE, POOL_SIZE is the number of power profiles in the pool (e.g., 20 for N=6 in Table 5), ƒ(⋅) is a function that maps the SEED to another integer and mod(a, b) represents modulo operation (i.e, remainder of a divide by b operation (i.e., a/b). In a situation where the transmitter chooses the power profile at random, the receiver may learn of the power profile through blind detection. In addition to detecting the data, the receiver also detects the power profile. This is useful as it reduces the overhead of signaling when the blind detection accuracy is high. Accuracy of the blind detection is high when the number of power profile patterns are small and/or easily detectable patterns are being used in random selection.

In some embodiments, a control input i₄ to the power profile block 508 in FIG. 5, is used to control power profile parameters. For example, i₄ may determine the index (row, or row and column in the event of multiple columns) of a power profile from within a stored table, a value of xdB, a parameter of power profile hopping profile etc.

In some embodiments, the power profiles are designed such that the power levels of colliding symbols are sufficiently different in order to achieve sufficient successive interference cancellation (SIC) gain and hence, effectively mitigate the impact of the collision/interference, and such that the PAPR of the resulting NoMA signal remains low. For example, a higher value of x in the power profile patterns in Table 1 will result in higher power difference in colliding symbols which helps with SIC operation but higher value x can result in higher PAPR (due to higher amplitude symbol constructive addition). On the other hand, a lower value of x results in lower power difference in colliding symbols which helps little for SIC operation while a lower value of x can lead to lower PAPR (constructive addition of lower amplitude symbols). Some patterns, i.e., indices 0 and 1 in Table 1, have less PAPR due to less constructive addition of symbol amplitudes.

As mentioned above, the power profiling can be applied in a symbol-level processing block, when present, or in a separate block, before or after the symbol-level processing block. After the power profiling is completed, an optional waveform operation such as DFT-spreading 510 can be applied. In an alternative approach, the power profile can be applied after the DFT-spreading (more generally after a waveform operation). Note that DFT-spreading may applied to obtain DFT-s-OFDM or DFT-spread OFDM. In case of CP-OFDM waveform, the DFT-spreading block is absent. After the (optional) DFT-spread block, a resource mapping block 512 will map the symbols to the OFDM resource grid/perform symbol to resource element mapping. Other waveform and related operations in the transmission chain may be performed in subsequent blocks (not shown) before transmitting the NoMA signal to a receiver.

It should be noted that different power profiles have different PAPR properties. For example, alternating power profile profiles (for example those with index 0, 1 in Table 1) have low-PAPR properties compared to the other power profiles. Therefore, cell-edge transmitters may select from or be assigned such power profile profiles. More generally, knowledge of the PAPR of the power profiles with a pool of power profiles can be used when selecting and/or assigning a power profile for a given transmitter. This can take into account the location of the transmitter, or the distance between the transmitter and the receiver. When the transmitter selects the power profile, it may select the power profile with the objective of achieving an acceptable PAPR for a given distance from the receiver.

Wireless signals for NoMA transmission may be generated using one or more signatures with various methods such as symbol-level operations, bit-level operations, or a combination thereof. To generate a NoMA signature, one or more input controls such as i₁-i₄ along with other signaling information or parameters can be used. Symbol-level operations may include spreading (linear or non-linear), scrambling, sparse spreading/mapping, power profiling and the like. Bit-level operations may include bit scrambling, interleaving, bit repetition, puncturing, pruning, and the like. A signature and/or NoMA signal may be produced by a combination of bit and/or symbol domain processes or operations. For example, linear spreading together with bit interleaving may produce a NoMA signal. In another example, symbol spreading with symbol scrambling may produce a NoMA signal. In yet another example, bit interleaving and bit scrambling may produce a NoMA signal. In another example, power profiling applied in the symbol-level processing block produces a NoMA signal. In another example, power profiling applied in the power profile block produces a NoMA signal. In another example, power profiling applied in the symbol-level processing block or power profile block together with other symbol-level processing such as spreading, sparse mapping produce a NoMA signal. In another example, power profiling applied in the symbol-level processing block or power profile block together with bit-level processing such as bit scrambling produces a NoMA signal. A combination of symbol domain, bit domain or both may produce a NoMA signal. Such operations can be achieved through the bit-level processing block or symbol-level processing block or both. Such symbol-level or bit-level operations may be used for embedding or otherwise applying one or more signatures, to the signal generated at the transmitter side. Then, at the receiver side, the signatures embedded in the transmitted signal are exploited to separate the signals.

In some scenarios, without any symbol-level or bit-level operations (that is, without embedding a signature at the transmitter side), multiple transmitters each generate a respective signal and transmit the respective signal over the same physical resource. Therefore, the multiple transmissions from the multiple transmitters collide with each other. Such collision-based transmissions may be considered a NoMA transmission or multi-user multiple-input multiple-output (MIMO) or contention-based transmission. As such, in this scenario, signals from different transmitters do not include any bit-level or symbol-level operations on the signals and each signal is a regular transmission without embedding any signature; the signals may be separated at the receiver using multiple antenna reception. Such generation of a NoMA signal by embedding or using a signature or without embedding signature may correspond to a NoMA method. The provided power profile pattern can be applied to any such NoMA signals.

By configuring the blocks in FIG. 5 and by setting the input controls i₁-i₄, the NoMA signal is generated. As described, each of the blocks may perform an operation to collectively generate the NoMA signal.

In one example, the bit-level processing block 502 performs bit-scrambling to randomize the inter-beam/inter-cell interference, the bits-to-symbol mapper 504 performs legacy modulation such as

$$BPSK , \frac{π}{2} - BPSK , QPSK , 16 \text{-} QAM , 256 \text{-} QAM , 1024 \text{-} QAM ( m \text{-} QAM )$$

and the power profile block 508 applies the power profile to generate a NoMA signal.

In another example, the bits-to-symbol mapper 504 performs non-linear spreading and the symbol-level processing block 506 performs sparse mapping (non-linear spreading and sparse mapping together defining a part of signature (partially)), the symbol-level processing block 506 also performs symbol scrambling to randomize the inter-beam/inter-cell interference and power profile block 508 applies the power profile to generate a NoMA signal.

In another example, the bits-to-symbol mapper 504 performs non-linear spreading and the symbol-level processing block 506 performs sparse mapping (non-linear spreading and sparse mapping together defining a part of a signature) and the bit-level processing block 502 performs bit scrambling to randomize the inter-beam interference and the power profile block 508 applies the power profile to generate a NoMA signal.

In another example, the bits-level processing block 502 performs bit-interleaving and the bits-to-symbol mapper 504 performs legacy modulation and the symbol-level processing block 506 performs sparse mapping (interleaving and sparse mapping together defining a signature in part), the symbol-level processing block 506 also performs symbol scrambling to randomize the inter-beam interference and the power profile block 508 applies the power profile to generate a NoMA signal.

In another example, coded bits are connected to the bits-to-symbol mapping block 504 and the bits-to-symbol mapping block 504 performs legacy modulation, the symbol-level processing block 506 performs sparse mapping (sparse mapping defining a signature in part), the symbol-level processing block 506 performs symbol scrambling to randomize the inter-beam/inter-cell interference and the power profile block 508 applies the power profile to generate a NoMA signal.

In another example, the bit-level processing block 502 performs bit-scrambling to randomize the inter-beam interference, the bits-to-symbol mapper 504 performs legacy modulation, the symbol-level processing block 506 performs sparse mapping (sparse mapping defining a signature in part) and the power profile block 508 applies the power profile to generate a NoMA signal.

In another example, the bit-level processing block 502 performs bit-scrambling to randomize the inter-beam interference, the bits-to-symbol mapping block 504 performs legacy modulation, the symbol-level processing block 506 performs symbol spreading (where symbol spreading defines the device-based signature in part) and the power profile block 508 applies the power profile to generate a NoMA signal.

In another example, the bit-level processing block 502 performs bit-scrambling to randomize the inter-beam interference, the bits-to-symbol mapping block 504 performs legacy modulation, the symbol-level processing block 506 performs symbol spreading and symbol-level scrambling (where symbol spreading and scrambling together defining a device-based signature in part) and the power profile block 508 applies the power profile to generate a NoMA signal.

In another example, the bit-level processing block 502 performs bit-scrambling to randomize the inter-beam interference, the bits-to-symbol mapping block 504 performs legacy modulation, the symbol-level processing block 506 performs symbol spreading and symbol sparse-mapping (where symbol spreading and sparse mapping together defining a device-based signature in part) and the power profile block 508 applies the power profile to generate a NoMA signal.

In some embodiments, the power profiling may be enabled and disabled via suitable configurations and/or control inputs (for example, controls i₁-i₄, in FIG. 1 or by using other suitable methods). When the power profiling is enabled, the power profile method is used in NoMA signal generation. When the power profiling is disabled, the power profiling is not used in NoMA signal generation.

The signal generated from the aforementioned method is mapped to an OFDM resource grid. When the signal is mapped to the REs of a slot, such power profiling may be considered intra-slot power profiling as discussed previously. Other transmitters may share the same physical resources to map their signals so that transmissions from different transmitters collide with each other creating interference.

### NoMA Receiver

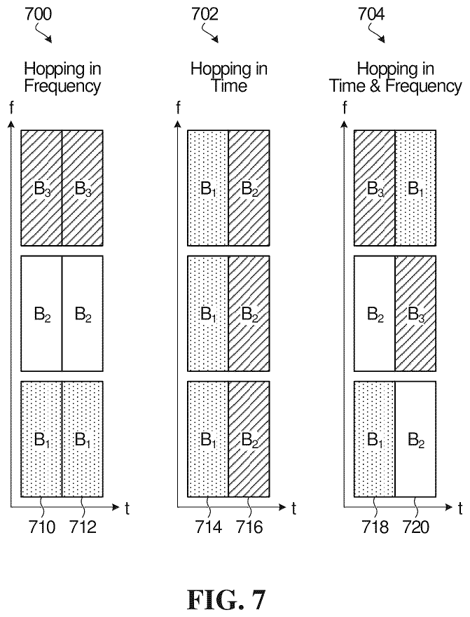

As mentioned earlier, the power profile may be designed such that the power levels of colliding symbols are sufficiently different in order to achieve sufficient successive interference cancellation (SIC) gain and hence, effectively mitigate the impact of collision/interference. A general block diagram of a multi-user receiver is depicted in FIG. 6. In the multi-user receiver of FIG. 6, a received signal is processed in a detector block 600; the output of the detector block 600 is fed to a decoder block 602. Based on an output of the decoder block 602, an interference cancellation (IC) block 604 produces a cancellation signal which is fed back to the detector block 600.

The algorithms for the detector block (for data) 600 may, for example, be one of minimum mean square error (MMSE), matched filter (MF), elementary signal estimator (ESE), maximum a posteriori (MAP), message passing algorithm (MPA), expectation propagation algorithm (EPA). The interference cancellation performed in the IC block 604 may, for example, be hard, soft, or hybrid, and can be implemented in serial, parallel, or hybrid. The IC block 604 receive the received signal as an input for some types of IC implementations. The IC block 604 may or may not be used. If IC is not used, an input of interference estimation to the decoder block 602 may be required for some cases. An input to the IC block 604 may come directly from the detector block 600 for some cases. Therefore, the receiver separates the colliding transmissions and use of the power profile enhances performance of the receiver.

### Measurements and Reporting

In order for the receiver side/BS/network side to determine which power profile to use with what parameters, resource assignment for NoMA transmission etc., the transmitter/device side may perform certain measurements and inform the network side of the measurements. For example, using a downlink reference signal such as a demodulation reference signal (DMRS), phase tracking reference signal (PTRS), channel state information-reference signal (CSI-RS), the UE side may measure a level of channel correlation or channel state information. Such measurements or information is reported to the transmitter side/BS/network side through signaling such as an uplink control channel or RRC signaling or other methods.

In order for the receiver side/BS/network side to determine which power profile to use with what parameters, and to perform resource assignment for NoMA transmission etc., the receiver side BS/network side may perform certain measurements. For example, using an uplink reference signal such as DMRS, sounding reference signal (SRS), preamble, the BS side may measure the level of channel correlation or channel state information. Such measurements or information is reported to the transmitter side through signaling such as downlink control channel or RRC signaling or other methods. Measured or reported information can also be shared with other BSs/transmit receive points (TRPs) by the serving BS/TRP.

### Power Profile Hopping

In some embodiments, in order to randomize the interference and extend the pool of power profiles (hence to correspondingly extend the MA signature pool), power profile hopping is used.

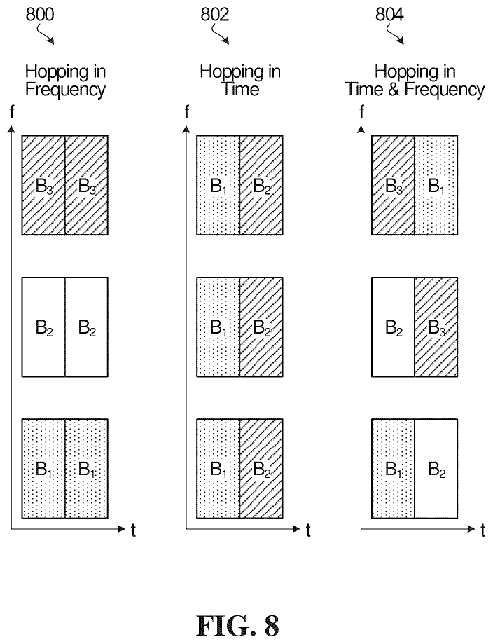

An example power profile hopping in time, frequency or both time & frequency is shown in FIG. 7. Time is on the horizontal axis, and frequency is on the vertical axis. Each box represents a block of symbols. Different hatchings represent different power profiles, and each hatching also has a respective label B₁, B₂ or B₃. Each example in FIG. 7 shows a different hopping pattern, as a specific arrangement in time and frequency of the power profiles. In alternative implementations of hopping, each box may represent different level of resource granularity in time and frequency domain, for example, a block or group of symbols, or one or more slot(s) in time or a block or group of subcarriers, one or more RB(s), RBGs in frequency or REGs.

Generally indicated at 700 is an example of power profile hopping in frequency. Within a first OFDM symbol 710, different profiles B₁, B₂ or B₃ are applied in different frequency resources. The same profiles are used in a second OFDM symbol 712. In this example, different power profiles are being used for different frequency bands/subcarriers. Since the applied profile changes with frequency, but not with time, this example is frequency hopping.

Generally indicated at 702 is an example of power profile hopping in time. In this example, different power profiles are being used in time/OFDM symbols. Within a first OFDM symbol 714, profile B₁ is used in all of the frequency resources. Within a second OFDM symbol 716, profile B₁ is used in all of the frequency resources. Since the applied profile changes with time, but not with frequency, this example is time hopping.

Generally indicated at 704 is an example of power profile hopping in time and frequency. Within a first OFDM symbol 716, different profiles B₁, B₂ or B₃ are applied in different frequency resources. Within a second OFDM symbol 718, different profiles B₂, B₃ or B₁ are applied in different frequency resources. In this example, different power profiles are being used in time/OFDM symbols and frequency/subcarriers. It should be noted that for DFT-s-OFDM, the notion of time and frequency is interchanged. Since the applied profile changes with both time and frequency, this example is time and frequency hopping.

It is noted that the examples of FIG. 7 assume localized hopping in both time and frequency meaning hopping occurs between adjacent frequency resources and/or adjacent time resources. However, alternatively, hopping patterns can be defined that involve hopping in time and/or frequency between distributed (i.e. non-adjacent) time resources (e.g. non-consecutive OFDM symbols) and/or non-adjacent frequency resources (e.g. non-adjacent sets of OFDM subcarriers to name a specific example).

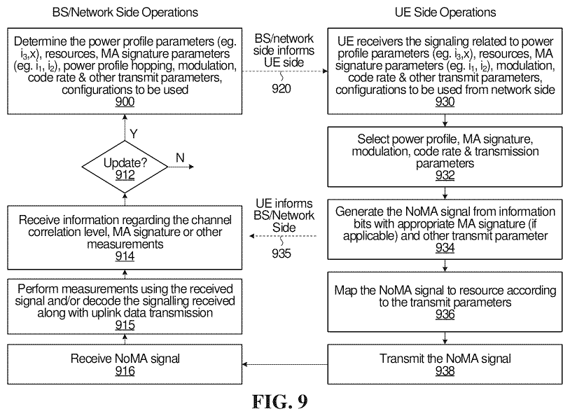

Another set of examples of power profile hopping in time, frequency or both is shown in FIG. 8, indicated at 800, 802, 804 respectively. In the examples of FIG. 7, the resource allocation is localized, whereas in the examples of FIG. 8, the resource allocation is distributed, but otherwise, the profiles hop in a similar manner to FIG. 7. Subcarriers are adjacent to one another in the localized resource allocation (FIG. 7). In the distributed allocation, subcarriers are in different blocks (3 blocks in FIG. 8).

The power profile patterns shown in FIGS. 7 and 8 are specific examples only. Depending on the number of devices transmitting in given resource(s), transmitter side parameters such as modulation, coding rate (MCS), PAPR requirements, receiver capability, transmitter capability or other system parameters, different hopping patterns may be used. For example, hopping pattern suitable for a target scenario, say low PAPR hopping patterns, a pool of hopping patterns may be defined in a table. The hopping pattern to be used by the transmitter side may be assigned by the network side. The index of a specific power profile hopping pattern to use may be assigned to a transmitter by RRC, MAC-CE, DCI, L1/L2 control signaling, as a result of which the hopping pattern becomes known to both the transmitter and the receiver. Hopping pattern to be used by the transmitter side may be selected or chosen by the transmitter side at random. Blind detection of hopping pattern, power profile may be required for proper operation in this case in addition to the data detection/decoding. Hopping pattern to be used by the transmitter side may be determined by the transmitter based on a formula in some embodiments. For example, the transmitter may select, choose or determine the power profile hopping pattern index from a formula, for example, mod (g (SEED), HOPPING_POOL_SIZE) where SEED is an input to the function g(⋅). For example, SEED may be a transmitter specific identifier such as a radio network temporary identifier (RNTI) (an example of a UE identifier), or a random number assigned by the network or generated by the device/UE, HOPPING_POOL_SIZE is the number of power profiles hopping pattern in a hopping pattern pool, g(⋅) is a function that maps the SEED to another integer and mod (a, b) represents modulo operation. The hopping pattern to be used by the transmitter side is obtained using the determined or calculated or computed hopping pattern index, for example, from a table of hopping patterns. A set of power profile hopping patterns can also be obtained, computed or determined from formulas. Parameters, configurations required for hopping pattern selection or determination or computation of set of hopping patterns may be signaled by RRC, MAC-CE, DCI, L1/L2 control signaling. Power profile hopping can be applied in grant-based/scheduled transmission or grant-free/configured-grant transmission scenarios.

### Signaling

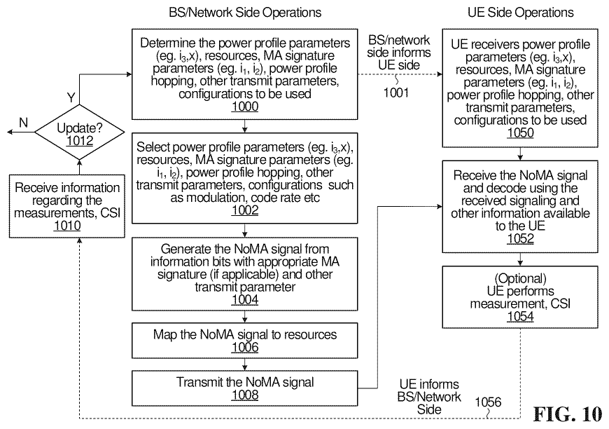

For proper operation of the system, the transmitter and the receiver may exchange information. One specific example of such information exchange is shown in FIG. 9. BS/Network side operations are indicated at 900, 912, 914, 916 while UE side operations are indicated at 930, 932, 934, 936, 938. The exchange of information is indicated at 920 and 935.

At 900, the BS/Network side determines power profile parameters (e.g. i₃, x), resources, MA signature parameters/configurations (e.g. i₁, i₂), power profile hopping parameters/configurations, modulation and code rate and other transmission parameters and configurations to use. At 920, the BS/network informs the UE side of the determined parameters and configurations. At 914, the BS/Network side receives information regarding the channel correlation level, MA signature or other measurements from the UE side. For example, such signaling can use uplink control channel such as PUCCH (physical uplink control channel) or uplink data channel such as PUSCH (physical uplink shared channel). Based on this, at 912, the BS/Network decides whether to update the parameters by performing step 900 again, and sends an update to the UE side. Such update may be applicable for current transmission or in future, for example, UE side is expected to update the parameters/configuration after receiving the signaling to the UE side or apply the configurations/parameters received based on a pre-configured timer. At 916, the BS/network receives the NoMA signal using the determined profile, parameters etc. Upon receiving the NoMA signal from the UE side, at 915, BS/Network side decodes the received signal and also can optionally perform measurements using the received signal (for example NoMA signal or other received signals in uplink such as uplink reference signals (for example SRS, PTRS, DMRS) or both) and/or decode the signaling received along with uplink data transmission. Such measurements or signaling information is being used at 914. For parameters and configurations signaling at 920, RRC, DCI, MAC-CE or L1/L2 signaling or other signaling (e.g., RRC state transition instruction/configuration messages (RRCRelease message), SIB, paging mechanism) can be used. For parameters and configurations signaling at 935, RRC, UCI (uplink control information), MAC-CE or L1/L2 signaling can be used. Some parameters or configuration can be transparent, i.e., no explicit signaling is required. For example, data and DMRS using the same precoder/spatial filter, no explicit indication of precoder/spatial filter is required for successful decoding and therefore, decoding can be done transparent to the precoder/spatial filter being used.

At 930, the UE side receives the configurations and parameters from the BS/Network side via RRC, MAC-CE, L1/L2 or DCI signaling or other signaling (e.g., RRCRelease message, SIB, paging mechanism). At 932, the UE side selects a power profile, MA signature, modulation, code rate, and transmission parameters, taking into account the configurations and parameters received from the network side. Using the parameters and configuration received and/or based on measurements made by UE side from one or more received downlink reference signal(s) such as SSB, CSI-RS, DMRS, PTRS or others, at 934, the UE generates a NoMA signal, maps the NoMA signal to resources according to the transmit parameters at 936, and transmits the NoMA signal at 938. Optionally, the UE may also take measurements (as described earlier) and report back to the BS/Network side at 935.

Another example information exchange is shown in FIG. 10. At 1000, the BS/Network side determines power profile parameters (e.g. i₃, x), resources, MA signature parameters (e.g. i₁, i₂), power profile hopping parameters, modulation and code rate and other transmission parameters and configurations to use. At 1001, the BS/network informs the UE side of the determined parameters and configurations. RRC, MAC-CE, L1/L2 or DCI signaling or other methods (e.g., RRCRelease message, SIB, paging mechanism) can be used for such signaling. At 1010, the BS/Network side receives information regarding the measurements, CSI and/or other information, such as the channel correlation level, MA signature or other measurements from the UE side. RRC, MAC-CE, L1/L2 or UCI signaling or other methods can be used for such signaling. As part of 1010, the BS/Network side may also perform measurements on its own from one or more received uplink reference signal(s) such as SRS, DMRS, PTRS or others. Based on the parameters and configuration received and/or based on the measurements performed, at 1012, the BS/Network decides whether to update the parameters by performing step 1000 again, and sends an update to the UE side. Such update may be applicable for current transmission or in future, for example, UE side is expected to update the parameters/configuration after receiving to the UE side or based on a pre-configured timer. At 1002, the BS/network side selects a power profile, MA signature, modulation, code rate, and transmission parameters, taking into account the configurations and parameters determined at 1000. Using the parameters and configurations and the selected power profile, at 1004, the BS/network generates a NoMA signal, maps the NoMA signal to resources according to the transmit parameters at 1006, and transmits the NoMA signal at 1008.

At 1050, the UE side receives the configurations and parameters from the BS/Network side via RRC, MAC-CE, L1/L2 or DCI signaling or other methods (e.g., RRCRelease message, SIB, paging mechanism). At 1052, the UE receives the NoMA signal and decodes it using the received signaling and other information available to the UE. Optionally, the UE may also take measurements (as described earlier) at 1054 and report back to the BS/Network side at 1056. In the described embodiments, the power profile can be viewed as a power allocation pattern. A transmitter may have a limit on power it can use for a transmission. Out of this power budget, the transmitter can determine how much to use in different parts of transmission resources such as subcarriers (i.e., power allocation across subcarriers). In another example of downlink transmission to multiple users, the BS can allocate different power levels to different user signals so that every user signal has sufficient power to be received for decoding/detection and less interference to other transmissions. In these embodiments, power is allocated using pre-determined patterns.

In another embodiment, the described method can be implemented or realized using a power control mechanism whereby the network side can control how much power a transmitter emits (to control interference to other transmitters within the cell while receiving sufficient power level for decoding), in which case the power profile can be viewed as a power control pattern. Power control serves the purpose of controlling the interference, mainly towards other cells or can be used in case of colliding transmission within the same cell. Wireless communication systems use a set of procedures and/or algorithms and/or signaling information to determine the transmit power (power control), particularly important in uplink and sidelink. Therefore, the power control can be considered as a set of algorithms, procedures and tools by which the transmit power for different physical channels and signals is controlled to ensure that they, to the extent possible, are received by the network side or receiving device at an appropriate power level. In the case of a physical channel, the appropriate power is simply the received power needed for proper decoding of the information carried by the physical channel. At the same time, the transmit power should not be unnecessarily high or vary because that would cause unnecessarily high interference to other transmissions. The appropriate transmit power will depend on the channel properties, including the channel attenuation and the noise and interference level at the receiver side. It should also be noted that the required received power is directly dependent on the data rate. If the received power is too low one can thus either increase the transmit power or reduce the data rate. For example, for PUSCH transmissions, there is a relationship or connection between power control and link adaptation (transmission rate control). In case of NoMA transmissions where transmissions from different devices uses or share the same physical channel or physical resources, transmissions inherently collide with one another causing interference to one another and the power level of each transmission is important for separating the signals (i.e., decoding the transmitted data). For example, if the received power of one user transmission signal is significantly different from that of another user transmission signal, a receiver can use the power difference between them to successively decode the two transmission signals. This approach is also called power domain NoMA.

The power control can be a combination of:
Open-loop power control, including support for fractional path-loss compensation, where the UE estimates the uplink path loss based on downlink measurements and sets the transmit power accordingly. Similarly, sidelink path loss can be estimated based on the reverse link or channel reciprocity.
Closed-loop power control based on explicit power-control commands provided by the network. In practice, these power-control commands are determined based on prior network measurements of the received uplink power, thus the term “closed loop.” Similarly, for a sidelink, the power-control commands are determined based on prior network measurements, measurements or reports from the reverse link or channel reciprocity.

Power control for transmission can depend on many parameters. These parameters may include one or more of maximum allowed transmit power per carrier or per user or per beam or per transmit and receive beam pair or combination thereof, target received power, path loss, transmission modulation and coding rate, transmission bandwidth (i.e., number of resource blocks, subcarrier spacing). Moreover, power control may depend on the power adjustment due to the closed-loop power control and other objectives such as fractional path-loss compensation (network-configurable parameter related to path-loss compensation).

For example, the transmit power P can be expressed as

$$P = min ( {P}_{ma x} , {P}_{0} ( j ) + α ( j ) P L ( q ) + 10 {log}_{10} ( {2}^{μ} \cdot {M}_{R B} ) + {Δ}_{T F} + δ ( l ) ) \qquad ( 1 )$$

Here, Pₘₐₓ represents a maximum transmit power, for example, maximum transmit power per carrier, P₀(j) is a network configurable parameter that can be viewed as a target received power, α(j) represents a network configurable parameter for configuring fractional pathloss compensation, μ is an index of subcarrier spacing, M_{RB} represents the number of resource blocks assigned for transmission, Δ_{TF} represents the transmission power impact from modulation scheme and channel coding rate, δ(l) represents the power adjustment due to closed-loop power control.

The quantity PL(q) may consider a path loss estimate including the beam forming gains. For example, in uplink transmission, transmitter/device side beam forming and receiver/base-station beam forming effect the path-loss. PL(q) can be considered the path-loss estimate for a beam pair (transmitter side and receiver side beams). A device may measure and calculate multiple values PL(q), q=0, 1, . . . which can be thought of as multiple path loss estimates, for example, corresponding to multiple transmit side and receive side beam pairs. Performing measurements on the beam pairs can be done using the downlink reference signals such as CSI-RS, SSB, DMRS, PTRS etc. at a device. Such device side measurements may be reported to the network side. In another approach, performing measurements on the beam pairs can be done using the uplink reference signals such as SRS, DMRS, PTRS etc. with measurements done at the BS/the network side (therefore, explicit reporting may not be required). Similarly, measurements can be done in a side link using a reference signal in the side link.

The open loop parameters P₀(j) and fractional path loss compensation α(j) indicates multiple open loop parameters pairs. For example, one pair of parameters may correspond to configured grant transmission (also known as grant-free transmission) while another pair of parameters may correspond to scheduled transmission (also known as grant-based transmission).

The expression P₀(j)+α(j) PL(q) represents basic open-loop power control supporting fractional path-loss compensation. In the case of full path-loss compensation, corresponding to α=1, and under the assumption that the path-loss estimate PL is an accurate estimate of the path loss, the open-loop power control adjusts the transmit power so that the received power aligns with the “target received power” P₀. The quantity P₀ can be provided as part of the power control configuration and would typically depend on the target data rate but also on the noise and interference level experienced at the receiver from other transmissions (i.e., other transmissions in the same cell such as NoMA users or transmissions from different cells).

In the case of fractional path-loss compensation, corresponding to α<1, the path loss will not be fully compensated for. Therefore, the received power can vary on average, for example, depending on the location of the device within the cell, or how far the transmitter is from the receiver. When the receiver is further away from the transmitter, received power is lowered for devices with higher path loss. The lower received power can be compensated for by adjusting the uplink data rate accordingly. The benefit of fractional path-loss compensation is reduced interference to neighbor cells. This comes at the price of larger variations in the service quality, with reduced data-rate availability for devices closer to the cell border/edge.

The term Δ_{TF} may model how the required received power varies when the number of information bits per resource elements/physical resources varies due to different modulation schemes and channel-coding rates.

In the power-control, the open-loop parameters P₀ and α are associated with a parameter j. This simply reflects that there may be multiple open-loop-parameter pairs {P₀, α}. For example. different open-loop parameters will be used for different types of transmission (such as random-access “message 3” transmission, grant-free transmissions, and scheduled transmissions, NoMA transmission). In another example, there is also a possibility to have multiple pairs of open-loop parameter for scheduled transmission, where the pair to use for a certain transmission can be selected based on a reference signal such as SRS (similar to the selection of path-loss estimates as described above). This means that the open-loop parameters P₀ and α will depend on the beams.

The parameter l is the parameter for the closed-loop process, i.e., power adjustment due to closed loop power control δ(l). Power control δ(l), l=1, 2, . . . may allow for the configuration of multiple closed-loop processes. Similar to the possibility for multiple path-loss estimates and multiple open-loop-parameter sets, the selection of closed-loop process, can be tied to an uplink, downlink or sidelink reference signal such as SRS, CSI-RS, SSB or others.

The above-described proposed profiling or application of a power profile pattern (power allocation pattern or power control pattern) adjusts the power of a transmission according to a prior known power profile, the power profile specifying amplitude or power scaling factors. This can be implemented using the power control process.

In conventional power control, a power P is defined for an entire transmission and therefore, the power profiling approach is used to scale the power of the entire signal. In other words, amplitudes of all the symbols are adjusted to satisfy the power control value. For example, a sequence of symbols s=s₁, s₂, . . . , SM are drawn from power normalized constellation and therefore, average power of s is M i.e., (i.e., E(|s|²)=M). Scaled or amplitude adjusted by \sqrt{P}, the symbol sequence has the power of the power control applied symbol is E(|\sqrt{P} s|²)=PM. In accordance with an embodiment of the application, instead of using a power P defined for an entire transmission, each subset of symbols from the sequence s is power scaled (or amplitude adjusted) as specified by a power profile/profile. In other words, a power profile/profile is applied to a set or group of symbols of length N where N≤M. For example, the power of a group of symbols of length N may be adjusted according to the values shown in the Table 1. For example, the power of a block of power normalized symbols (s₀, s₁, s₂, s₃, s₄, s₅)^{T} will be adjusted according to the (+x, −x, +x, −x, +x, −x), i.e., the power of so is adjusted x dB higher power and the power of s₁ is adjusted x dB lower power etc. The value of x is prior known, for example, specified by RRC signaling or other method to the transmitter side. Observe that the power of the group of symbols after applying the power profile is the same as the power of the normalized symbol sequence. The power normalized symbol means, symbols sᵢ, i∈{0, . . . , 5} have average power 1, i.e., [symbol] (sᵢ)=1, i∈{0, . . . , 5}. The power adjustment can be viewed as amplitude adjustment. For example, y=γs₀ where y has x dB higher power than s₀. For example, with

$$γ = \sqrt{1 {0}^{\frac{x}{10}}} ,$$

y has x dB higher power than s₀. The power profile application onto the group of symbols N repeated for M/N groups so that the entire symbol sequence is power or amplitude adjusted appropriately. The application of power profile onto the group of length N can be viewed as applying to a parts or portions of the transmit symbol sequence or transmit signal in accordance/as specified by the power profile/profile (Example Table 1). Moreover, application of power profile (an index from the Table 1) can also be viewed as applying a mask to the group of symbols. As a result, when the power profile applied to the entire sequence of symbols of length M (entire signal) or the group/block of symbols of length N (portion of signal), it can be viewed as defining a sequence of power control values P={p₁, p₂, . . . } for a sequence of symbols rather than a single value. As such this can be considered vectored or sequenced power control. The length of the power control values can be either M or N, i.e., P={p₁, p₂, . . . , P_{M}} or P={p₁, p₂, . . . , P_{N}}. In case of power profile hopping, P={p₁, p₂, . . . , P_{M}} obtained from the block/groups of length N and hopping profile (i.e., hopping indices). For example, 3 power profiles PP₁={p₁₁, p₁₂, . . . , P_{1N}}, PP₂={p₂₁, p₂₂, . . . , P_{2N}}, PP₃={p₃₁, p₃₂, . . . , P_{3N}} and hopping over them in PP₁, PP₂, PP₃ order may result in a power profile {p₁₁, p₁₂, . . . , P_{1N}, p₂₁, p₂₂, . . . , P_{2N}, p₃₁, p₃₂, . . . , P_{3N}}. As such, power profile hopping provides longer power profiles and randomize the interference from other transmission. Note that the hopped power profile may be sufficiently long for the entire length of symbols M or the hopped power profile may be repeated (and truncated if necessary) to fulfill the power profile for the entire length of symbols M. Observe that repeating the same power profile say PP₁ can be considered as without power profile/profile hopping.

In a similar manner, instead of applying the power profile over the power control value P in equation (1), power profile/profile can be applied on other parameters on the right hand side of the equation (1). For example, a power profile may be applied to P₀(j), α(j) or PL(q) or δ(l) or another parameter(s). For example, a power profile applied on P₀(j) can be viewed as P₀(j) [p₁, p₂, . . . , P_{M}]^{T} where a sequence of amplitude scaling factors {p₁, p₂, . . . , P_{M}} is applied to the P₀(j). In this notation, not applying power profile can be represented as P₀(j) [1, 1, . . . , 1]^{T}. Similarly, a power profile can be applied to other parameters. Furthermore power profile index hopping can be implemented.

It should be noted that the power control pattern or a power allocation pattern can be represented by power density level. Power density means the amount of power per unit of physical resource. The physical resource can be an RE, RB, subcarrier, slot or others. As such, the pattern or sequence of amplitude or power scaling factors can be represented/viewed/specified in terms of power density. Moreover, the power control pattern or power allocation pattern can be viewed as an offset from a reference power density value as well. The power density reference value can be normalized symbol power or the signal power with legacy NR power control or others. As such, power of the symbol or signal after applying the power control pattern or power allocation pattern can be specified or represented by a power density offset against a reference power density value. The reference power density value or power density offset value or both can be known to the transmitter side. For example, power density values or offset values or both can be signaled to the transmitter by RRC, MAC-CE, DCI, L1/L2 or other signaling mechanisms. In another example, power density values or offset values or both are calculated or derived based on a specification. In another example, power density values or offset values or both are calculated or derived or obtained based on both signaling and specification.

It should be noted that in a system that is generally configured to perform power profiling, a special case can be implemented in which no power profile is applied. From the network side, parameters for power control may be communicated via signaling such as RRC, DCI or MAC-CE or L1/L2 or other channels. In some embodiments, it is also possible to enable/activate or disable/deactivate the power profile from the network side, for example through the use of signaling.

The transmissions can be done by a transmitter in any one of the RRC states such as RRC_CONNECTED, RRC_INACTIVE or RRC_IDLE or others. Configurations and parameters for transmission can be signaled to the transmitter side via RRC, DCI or MAC-CE or L1/L2 or other signaling mechanism. For example, RRCRelease message that instructs/informs a device to transition to RRC_CONNECTED from RRC_INACTIVE states or vice versa can configure or signal the parameters suitable for transmission. Activation or deactivation of the use of power profiling can also be signaled by RRC state transition messages/signaling such as RRCRelease message. In a specific example, a transmitter receives a signaling such as RRCRelease message to transition from RRC_CONNECTED state to RRC_INACTIVE state where the configuration and parameters for power profiling are provided within the RRCRelease message and after the transition is completed (which was instructed by RRCRelease message or otherwise), transmissions take the configurations/parameters received via RRCRelease message for application of power profile for the transmissions. In yet another specific example, a transmitter receives a signaling as a part of initial access (where the initial-access functionality may include the functions and procedures by which a device initially finds a cell when entering the coverage area of a system) such as system information block (SIB) for example, SIB1 or others and the configuration/parameters for power profiling is provided within the SIB message and transmissions take the configurations/parameters received via SIB for application of power profile for the transmissions.

The physical resources of a wireless system can be viewed as a resource a grid. For example, the smallest unit of the resource grid is a resource element which made up of one subcarrier in frequency domain and one OFDM symbol in time domain. A resource block is defined as a block or a group of consecutive subcarriers in the frequency domain. A slot may be defined as a block or a group of OFDM symbols in time domain. In a given resource, several resource elements may be allocated for data transmission and some others for reference signal transmission. When the resources for a device are allocated by the network side, this is usually referred as scheduled transmission or grant-based transmission (transmission with a dynamic grant). When the transmission happens without a dynamic grant, this is usually referred to as grant-free or configured grant. In NR, there are two types of configured grant support, type 1 and type 2. In type 1, an uplink grant is provided by RRC, including activation of the grant and type 2, the transmission periodicity is provided by RRC and L1/L2 control signaling is used to activate/deactivate. As such, the network/scheduler allocates the resources and informs/configures the devices through signaling such as RRC, MAC-CE, DCI. The allocated resources can be localized in frequency domain where allocated subcarriers are contiguous/continuous/adjoining in frequency. Alternatively, the allocated resources can be distributed in frequency domain where allocated subcarriers are not contiguous/continuous/adjoining in frequency. The distributed or localized resource allocation may help devices improve performance, for example, by exploiting frequency diversity with distributed resource allocation. In another example, localized resource allocation can help reduce the PAPR in DFT spread OFDM. Moreover, transmission can happen in multiple slots (multiple blocks of OFDM symbols) in the time domain. For example, a slot may for be defined as 14 OFDM symbols in time domain and one transmission may occupy a several slots, contiguous or not in time. In such multiple slot transmission example, a slot may occupy/carry/transmit the repetition of a previous transmission (e.g., a second slot carry the same signal as the first slot). In another multiple slot transmission example, a slot may carry the additional redundancy bits of a previous transmission. In another multiple slot transmission example, a slot transmission may correspond to an independent transmission (carrying independent information bits from others).

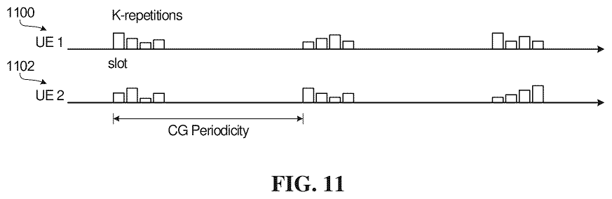

An example of applying the provided power profile/profile for multiple slot transmission is in FIG. 11. A first device 1 (UE 1) repeats a transmission K times in K slots 1100 (four times in four slots in the illustrated example). The power profile is applied to the K transmission, such that each transmission has a respective amplitude scaling factor applied to it. The device may have another transmission after a periodic delay which is shown as configured grant (CG) periodicity 1102. A first power profile is applied by UE1 in K repetitions and a second device (UE 2) can use another power profile. For the next transmission opportunity after the CG periodicity, the first device may use the same power profile or switch to another power profile (power profile hopping) as described earlier. This kind of application of power profile to multiple slots can be considered as inter-slot power profiling. Note that a power profile can be applied in this manner when there is enough power headroom for the device.

As described above, the application of a power profile in general can be done in time domain, frequency domain or both time and frequency domain. In a CP-OFDM waveform, the power/amplitude values specified in the power profile can be applied to the subcarriers. This can be referred as applying subcarrier level (one or more subcarriers) power profile or subcarrier level power profiling. Alternatively, the power/amplitude values specified in the power profile can be applied to a resource block (RB). This can be referred as applying RB level power profile or RB level power profiling. Note that once the frequency domain mapping is completed (after repeating the profile or hopping profile), the subsequent symbols/slots can apply/follow the same power profile. In CP-OFDM waveform, the power/amplitude values specified in the power profile can also be applied to the OFDM symbols. This can be referred as applying symbol-level power profile or symbol-level power profiling. Alternatively, the power/amplitude values specified in the power profile/profile can also be applied to the slots. This can be referred as applying slot level power profile or slot level power profiling. As such, power profiling can be defined/specified for different granularity of time or frequency domain.

In case of DFT-s-OFDM waveform, the notion of time and frequency is interchanged. In other words, the power/amplitude values specified in the power profile/profile can be applied to a vector of symbols (considered to be in time-domain) and the transform precoding (DFT spreading) transforms the symbols to the frequency domain.

It should also be noted that power profile can be defined at the RE level and an entire transmission consists of several REs, and the REs are mapped to the physical resources. This can be viewed as power profiling jointly in both frequency and time domain.

Numerous modifications and variations of the present disclosure are possible in light of the above teachings. It is therefore to be understood that within the scope of the appended claims, the disclosure may be practiced otherwise than as specifically described herein.

1. A method comprising:
communicating a signal over a wireless communications channel, the signal being based on a plurality of parts to each of which a respective amplitude scaling factor of a plurality of amplitude scaling factors has been applied, the plurality of amplitude scaling factors collectively forming a known power control pattern or a known power allocation pattern.

2. The method of claim 1, wherein the plurality of amplitude scaling factors does not depend on data carried by the signal.

3. The method of claim 1, wherein the communicating the signal comprises at least one of transmitting the signal or receiving the signal.

4. The method of claim 1, wherein the plurality of parts comprises:
a plurality of modulated symbols; or
a plurality of groups of resource elements; or
a plurality of groups of modulated symbols; or
a plurality of groups of subcarriers; or
a plurality of resource blocks; or
a plurality of modulated symbols for transmitting a forward error correction (FEC) codeword; or
a plurality of orthogonal frequency division multiplex (OFDM) symbols; or
a plurality of slots in the time domain; or
a plurality of retransmissions; or
a plurality of repetitions.

5. The method of claim 1, wherein the communicating the signal comprises transmitting the signal, the method further comprising:
performing power control pattern or power allocation pattern hopping in time or in frequency or in time and frequency.

6. The method of claim 1, further comprising:
obtaining power control pattern or power allocation pattern from a pool of power control patterns or power allocation patterns.

7. The method of claim 6, wherein the obtaining the power control pattern or the power allocation pattern from the pool of power control patterns or power allocation patterns comprises:
choosing the power control pattern or the power allocation pattern or an index of the power control pattern or the power allocation pattern at random;
obtaining the index of the power control pattern or the power allocation pattern using a formula;
choosing the power control pattern or the power allocation pattern to achieve an acceptable peak-to-average power ratio (PAPR);
measuring a channel to obtain channel measurements and choosing the power control pattern or the power allocation pattern based on channel measurements; or
receiving feedback reflecting the channel measurements and choosing the power control pattern or the power allocation pattern based on the feedback.

8. A non-transitory computer-readable medium storing instructions, when the instructions executed by an apparatus, cause the apparatus to perform operations including:
communicating a signal over a wireless communications channel, the signal being based on a plurality of parts to each of which a respective amplitude scaling factor of a plurality of amplitude scaling factors has been applied, the plurality of amplitude scaling factors collectively forming a known power control pattern or a known power allocation pattern.

9. The non-transitory computer-readable medium of claim 8, wherein the plurality of amplitude scaling factors does not depend on data carried by the signal.

10. The non-transitory computer-readable medium of claim 8, wherein the communicating the signal comprises at least one of transmitting the signal or receiving the signal.

11. The non-transitory computer-readable medium of claim 8, wherein the plurality of parts comprises:
a plurality of modulated symbols; or
a plurality of groups of resource elements; or
a plurality of groups of modulated symbols; or
a plurality of groups of subcarriers; or
a plurality of resource blocks; or
a plurality of modulated symbols for transmitting a forward error correction (FEC) codeword; or
a plurality of orthogonal frequency division multiplex (OFDM) symbols; or
a plurality of slots in the time domain; or
a plurality of retransmissions; or
a plurality of repetitions.

12. The non-transitory computer-readable medium of claim 8, wherein the communicating the signal comprises transmitting the signal, the operations further comprising:
performing power control pattern or power allocation pattern hopping in time or in frequency or in time and frequency.

13. The non-transitory computer-readable medium of claim 8, wherein the operations further comprise:
obtaining power control pattern or power allocation pattern from a pool of power control patterns or power allocation patterns.

14. An apparatus comprising:
at least one processor and a memory storing instructions thereon, when the instructions executed by the apparatus, cause the apparatus to perform operations, the operations comprising:
communicating a signal over a wireless communications channel, the signal being based on a plurality of parts to each of which a respective amplitude scaling factor of a plurality of amplitude scaling factors has been applied, the plurality of amplitude scaling factors collectively forming a known power control pattern or a known power allocation pattern.

15. The apparatus of claim 14, wherein the plurality of amplitude scaling factors does not depend on data carried by the signal.

16. The apparatus of claim 14, wherein the communicating the signal comprises at least one of transmitting the signal or receiving the signal.

17. The apparatus of claim 14, wherein the plurality of parts comprises:
a plurality of modulated symbols; or
a plurality of groups of resource elements; or
a plurality of groups of modulated symbols; or
a plurality of groups of subcarriers; or
a plurality of resource blocks; or
a plurality of modulated symbols for transmitting a forward error correction (FEC) codeword; or
a plurality of orthogonal frequency division multiplex (OFDM) symbols; or
a plurality of slots in the time domain; or
a plurality of retransmissions; or
a plurality of repetitions.

18. The apparatus of claim 14, wherein the communicating the signal comprises transmitting the signal, the operations further comprising:
performing power control pattern or power allocation pattern hopping in time or in frequency or in time and frequency.

19. The apparatus of claim 14, wherein the operations further comprise:
obtaining power control pattern or power allocation pattern from a pool of power control patterns or power allocation patterns.

20. The apparatus of claim 19, wherein the obtaining the power control pattern or the power allocation pattern from the pool of power control patterns or power allocation patterns comprises:
choosing the power control pattern or the power allocation pattern or an index of the power control pattern or the power allocation pattern at random;
obtaining the index of the power control pattern or the power allocation pattern using a formula;
choosing the power control pattern or the power allocation pattern to achieve an acceptable peak-to-average power ratio (PAPR);
measuring a channel to obtain channel measurements and choosing the power control pattern or the power allocation pattern based on channel measurements; or
receiving feedback reflecting the channel measurements and choosing the power control pattern or the power allocation pattern based on the feedback.
